(19) United States
(12) Patent Application Publication
(10) Pub. No.: US 2022/0195247 A1
(43) Pub. Date: Jun. 23, 2022

(54) STRUCTURAL BONDING TAPE WITH EPOXIDE MICROCAPSULES

(71) Applicant: 3M INNOVATIVE PROPERTIES COMPANY, St. Paul, MN (US)

(72) Inventors: Jian Li, London (CA); Catherine E. Bardeau, London (CA); Frank A. Brandys, London (CA); Kejian Zhang, London (CA); Weixing Hou, London (CA)

(21) Appl. No.: 17/442,971

(22) PCT Filed: Mar. 24, 2020
(86) PCT No.: PCT/IB2020/052743

§ 371 Date: Sep. 24, 2021

Related U.S. Application Data
(60) Provisional application No. 62/825,291, filed on Mar. 28, 2019.

(51) Int. Cl. C09J 7/10

(52) U.S. Cl. CPC C09J 7/10; C09J 2463/00; C09J 2301/412; C09J 2301/302

(57) ABSTRACT

Curable pressure sensitive adhesive tapes comprise: a) a pressure sensitive adhesive polymer; b) particles of encapsulated first epoxy resin (microcapsules) mixed into the pressure sensitive adhesive polymer; and c) a first epoxy curative. In some embodiments, the first epoxy curative is blended into the pressure sensitive adhesive. In other embodiments, the first epoxy curative is the pressure sensitive adhesive polymer. In some embodiments, the first epoxy curative may be an adduct of a second epoxy curative and a second epoxy resin in a ratio of at least 2:1 second epoxy curative to second epoxy resin. The particles of encapsulated first epoxy resin comprise a core of first epoxy resin within a shell comprising an organic polymer, and optionally a layer of oil-in-water Pickering emulsifier particles borne on a surface of the shells. Typically, the tape may be cured to form a structural bond between adherends.

The following references may be relevant to the general field of technology of the present disclosure: CN 105833811; EP 1373426; EP 1530617; EP 2700683; JP 2006/028254; US 2014/0272287; US 2015/0231588; U.S. Pat. Nos. 4,536,524; 5,601,761; 6,506,494; 7,927,514, 8,084,519, and WO 2011/126702.

### FIELD OF THE DISCLOSURE

This disclosure relates to structural bonding tapes including particles of encapsulated epoxy resin blended with epoxy curative and methods and products of their use.

### BACKGROUND OF THE DISCLOSURE

Pressure sensitive adhesives (PSA's) are widely used in both industrial, commercial and residential applications due to their many advantages including easy application, instant handling strength, neat and precise bondline, and no need for mixing and dispensing. However, the adhesion of PSA is relatively low with the best PSA's having a shear strength less than 3.45 MPa (500 psi), which limits their use in applications requiring structural adhesive strength. Traditional structural bonding tapes (SBT's) offer high adhesion, but typically lack adhesion prior to thermal activation. In addition, SBT products may have limited stability and may require cold storage and shipping with dry-ice.

### SUMMARY OF THE DISCLOSURE

Briefly, the present disclosure provides curable pressure sensitive adhesive tapes comprising: a) a pressure sensitive adhesive polymer; b) particles of encapsulated first epoxy resin (microcapsules) mixed into the pressure sensitive adhesive polymer; and c) a first epoxy curative. In some embodiments, the first epoxy curative is blended into the pressure sensitive adhesive. In other embodiments, the first epoxy curative is the pressure sensitive adhesive polymer. Typically the first epoxy curative is not encapsulated. In various embodiments, the first epoxy curative is selected from polyamides, polyamines, polymercaptans, anhydrides, imidazoles, and combinations thereof. Alternately, the first epoxy curative may be an adduct of a second epoxy curative and a second epoxy resin in a ratio of at least 2:1 second epoxy curative to second epoxy resin. In various embodiments, the second epoxy curative is selected from polyamides, polyamines, polymercaptans, anhydrides, imidazoles, and combinations thereof. The particles of encapsulated first epoxy resin comprise a core of first epoxy resin within a shell comprising an organic polymer. In various embodiments, the shell comprises a polymer selected from the group consisting of polyurea, polyurethane, polymethylene urea, cured epoxy resin, and combinations thereof. The particles of encapsulated first epoxy resin may additionally comprise a layer of oil-in-water Pickering emulsifier particles borne on a surface of the shells. Typically, the tape may be cured to form a structural bond between adherends. Additional embodiments of the curable pressure sensitive adhesive tapes of the present disclosure are described below under “Selected Embodiments.”

In another aspect, the present disclosure provides methods of affixing substrates, comprising: a) bringing a curable pressure sensitive adhesive tape according to any of the present disclosure into contact with a first substrate; b) bringing the curable pressure sensitive adhesive tape into contact with a second substrate; and c) heating the curable pressure sensitive adhesive tape to a curing temperature, which is a temperature sufficient to activate the particles of encapsulated first epoxy resin and cure the first epoxy resin. In various embodiments, the curing temperature may be not more than 200° C., not more than 170° C., not more than 110° C., or not more than 80° C. Additional embodiments of the method of affixing substrates of the present disclosure are described below under “Selected Embodiments.”

In another aspect, the present disclosure provides constructions comprising a first substrate bound to a second substrate by a layer of cured epoxy resin, wherein the layer of cured epoxy resin comprises shells comprising an organic polymer. In some embodiments, the shells comprise a polymer selected from the group consisting of polyurea, polyurethane, polymethylene urea, cured epoxy resin, and combinations thereof, and may additionally comprise a layer of oil-in-water Pickering emulsifier particles borne on a surface of the shells. Additional embodiments of the constructions of the present disclosure are described below under “Selected Embodiments.”

The preceding summary of the present disclosure is not intended to describe each embodiment of the present invention. The details of one or more embodiments of the invention are also set forth in the description below. Other features, objects, and advantages of the invention will be apparent from the description and from the claims.

In this Application:

“activated” or “activation”, with regard to particles of encapsulated epoxy resin, means altered (e.g., by heat or mechanical disruption) so as to allow chemical reaction between the epoxy resin and species external to the particles, and may include without limitation shell rupture, shell wall thinning, shell wall softening, shell wall dissolution, or shell wall permeabilization;

“directly bound” refers to two materials that are in direct contact with each other and bound together;

“free-standing film” means a film that is solid at normal temperature and pressure and has mechanical integrity independent of contact with any supporting material (which excludes, inter alia, liquids, surface coatings dried or cured in situ such as paints or primers, and surface coatings without independent mechanical integrity);

“(meth)acrylate” includes, separately and collectively, methacrylate and acrylate;

“normal temperature and pressure” or “NTP” means a temperature of 20° C. (293.15 K, 68° F.) and an absolute pressure of 1 atm (14.696 psi, 101.325 kPa);

“oil-in-water Pickering emulsifier particles” means particles suitable as Pickering emulsifiers in an oil-in-water emulsion, which may have surfaces somewhat more hydrophilic than hydrophobic in character or evenly hydrophilic/hydrophobic in character (which may be reflected in exhibiting a contact angle of the particle surface with water of 50-95° or 60-90°), and which may have an average diameter of 5-1000 nanometers;

“pressure sensitive adhesive (PSA)” means materials having the following properties: a) aggressive and permanent tack, b) the ability to adhere with no more than finger pressure, c) the ability to adhere without activation by any energy source, d) sufficient ability to hold onto the intended adherend, and preferably e) sufficient cohesive strength to be removed cleanly from the adherend; which materials typically meet the Dahlquist criterion of having a storage modulus at 1 Hz and room temperature of less than 0.3 MPa; and

“structural adhesive” means an adhesive that binds by irreversible cure, typically with a strength when bound to its intended substrates, measured as stress at break (peak stress) using the overlap shear test described in the Examples herein, of at least 4.14 MPa (600 psi), more typically at least 5.52 MPa (800 psi), in some embodiments at least 6.89 MPa (1000 psi), and in some embodiments at least 8.27 MPa (1200 psi).

All scientific and technical terms used herein have meanings commonly used in the art unless otherwise specified.

As used in this specification and the appended claims, past tense verbs such as “coated” and are intended to represent structure, and not to limit the process used to obtain the recited structure, unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

### BRIEF DESCRIPTION OF THE DRAWING

FIG. 1 schematically depicts a process of forming particles of encapsulated epoxy resin using a Pickering emulsifier.

FIGS. 2(a)-(d) are scanning electron micrographs of particles of encapsulated epoxy resin as described in the Examples herein.

### DETAILED DESCRIPTION

The present disclosure provides curable pressure sensitive adhesive tapes comprising: a) a pressure sensitive adhesive polymer; b) particles of encapsulated first epoxy resin (microcapsules) mixed into the pressure sensitive adhesive polymer; and c) a first epoxy curative. In some embodiments, the first epoxy curative is blended into the pressure sensitive adhesive. In other embodiments, the first epoxy curative is the pressure sensitive adhesive polymer. Typically the first epoxy curative is not encapsulated. Typically, the tape may be cured to form a structural bond between adherends.

The present disclosure also provides particles of encapsulated first epoxy resin (microcapsules) comprising a) a core of first epoxy resin, within b) a shell comprising an organic polymer, and c) a layer of oil-in-water Pickering emulsifier particles borne on an outer surface of the shell. These particles may be used in liquid adhesive compositions, in the tapes described above, or in other applications. Since the curable epoxy is sequestered, the particles of encapsulated epoxy resin can be blended with epoxy curative to form one-part epoxy adhesives with long shelf life and high stability, yet which cure to form strong structural bonds.

### Particles of Encapsulated Epoxy Resin

Particles of encapsulated epoxy resin (microcapsules) according to the present disclosure comprise a core of curable epoxy resin enclosed in a shell. The outer surface of the shell may include an emulsifier.

Any suitable curable epoxy resin may be used, that is, any suitable organic compound having one or more oxirane rings polymerizable by a ring opening reaction. Suitable curable epoxy resins may include monomeric epoxy compounds and polymeric epoxy compounds and can be saturated or unsaturated, aliphatic, cycloaliphatic, aromatic or heterocyclic, or can comprise combinations thereof. Useful materials typically have at least two polymerizable epoxy groups per molecule (that is, polyepoxides) and, more preferably, from two to four polymerizable epoxy groups per molecule. In some embodiments the curable epoxy resin is a liquid at NTP. In some embodiments the curable epoxy resin is a solid at NTP.

Suitable curable epoxy resins may include the polyglycidyl ethers of polyhydric phenols (for example, bisphenol A derivative resins, epoxy cresol-novolac resins, bisphenol F derivative resins, epoxy phenol-novolac resins), glycidyl esters of aromatic carboxylic acids, glycidyl amines of aromatic amines, and the like, and mixtures thereof. Representative examples of aliphatic polyepoxides that can be utilized include 3′,4′-epoxycyclohexylmethyl-3,4-epoxycyclohexanecarboxylate, 2-(3′,4′-epoxycyclohexyl)-5,1″-spiro-3″,4″-epoxycyclohexane-1,3-dioxane, bis(3,4-epoxycyclohexylmethyl)adipate, the diglycidyl ester of linoleic dimer acid, 1,4-bis(2,3-epoxypropoxy)butane, 4-(1,2-epoxyethyl)-1,2-epoxycyclohexane, 2,2-bis(3,4-epoxycyclohexyl)propane, polyglycidyl ethers of aliphatic polyols such as glycerol or hydrogenated 4,4′-dihydroxydiphenyl-dimethylmethane, and the like, and mixtures thereof. Representative examples of aromatic polyepoxides that can be utilized include glycidyl esters of aromatic carboxylic acids (for example, phthalic acid diglycidyl ester, isophthalic acid diglycidyl ester, trimellitic acid triglycidyl ester, pyromellitic acid tetraglycidyl ester, and the like, and mixtures thereof); N-glycidylaminobenzenes (for example, N,N-diglycidylbenzeneamine, bis(N,N-diglycidyl-4-aminophenyl)methane, 1,3-bis(N,N-diglycidylamino)benzene, N,N-diglycidyl-4-glycidyloxybenzeneamine, and the like, and mixtures thereof); the polyglycidyl derivatives of polyhydric phenols (for example, the polyglycidyl ethers of polyhydric phenols such as 2,2-bis-[4-hydroxyphenyl]propane, tetrakis(4-hydroxyphenyl)ethane, pyrocatechol, resorcinol, hydroquinone, 4,4′-dihydroxydiphenyl methane, 4,4′-dihydroxydiphenyl dimethyl methane, 4,4′-dihydroxy-3,3′-dimethyldiphenyl methane, 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris-(4-hydroxyphenyl)methane); polyglycidyl ethers of novolacs (reaction products of monohydric or polyhydric phenols with aldehydes in the presence of acid catalysts), and the derivatives described in U.S. Pat. No. 3,018,262 (Schoeder) and U.S. Pat. No. 3,298,998 (Coover et al.), the descriptions of which are incorporated herein by reference, as well as the derivatives described in the Handbook of Epoxy Resins by Lee and Neville, McGraw-Hill Book Co., New York (1967) and in Epoxy Resins, Chemistry and Technology, Second Edition, edited by C. May, Marcel Dekker, Inc., New York (1988); and the like; and mixtures thereof. Suitable epoxy resins can be prepared by, for example, the reaction of epichlorohydrin with a polyol, as described, for example, in U.S. Pat. No. 4,522,958 (Das et al.), the description of which is incorporated herein by reference, as well as by other methods described by Lee and Neville and by May, supra. Many epoxide resins are also commercially available.

Particles of encapsulated epoxy resin (microcapsules) according to the present disclosure comprise a shell surrounding a core of curable epoxy resin. Any suitable shell material may be used. The shell should be capable of preventing chemical reaction of the curable epoxy resin with species external to the shell, until activated. Upon activation, the shell is altered such that the curable epoxy resin core may react with species external to the particle. Suitable shell materials may include organic polymers, such as, without limitation, polyurea, polyurethane, polymethylene urea, cured epoxy resin, and combinations thereof.

Particles of encapsulated epoxy resin may have an average diameter of 0.1-1000 micrometers, 1-1000 micrometers, 5-500 micrometers, or in some embodiments 30-300 micrometers.

Particles of encapsulated epoxy resin according to the present disclosure typically comprise an emulsifier as an artifact of their manufacture, typically present as a layer borne on the outer surface of the shell. Alternately, emulsifier may be removed after particle manufacture. In some embodiments, the emulsifier is oil-in-water

Pickering emulsifier particles. In some embodiments, the emulsifier is an organic polymeric surfactant, typically a non-particulate organic polymeric surfactant. In some embodiments, the emulsifier is a combination of oil-in-water Pickering emulsifier particles, organic polymeric surfactant, or non-particulate organic polymeric surfactant. In some embodiments, the particles of encapsulated epoxy resin comprise not more than 50 wt % (based on the weight of oil-in-water Pickering emulsifier particles) of an organic polymeric surfactant or non-particulate organic polymeric surfactant; in some not more than 10 wt %; in some not more than 5 wt %; in some not more than 1 wt %, and in some not more than 0.1 wt %. In embodiments where the emulsifier is oil-in-water Pickering emulsifier particles, the resulting particles of encapsulated epoxy resin may be resistant to aggregation.

Where a Pickering emulsifier is used, any suitable oil-in-water Pickering emulsifier particles may be used. Pickering emulsifiers are particulate emulsifiers having a mixed hydrophilic/hydrophobic character. Pickering emulsifiers suitable for oil-in-water emulsions are typically balanced in hydrophilic/hydrophobic character or somewhat more hydrophilic in character. In some instances, the desired balance of hydrophilic/hydrophobic properties can be characterized in terms of contact angle of the particle surface with water. Contact angle may be measured by any suitable method, such as the method described in Paunov, “Novel Method for Determining the Three-Phase Contact Angle of Colloid Particles Adsorbed at Air-Water and Oil-Water Interfaces”, Langmuir 2003, 19, 7970-7976; the contents of which is incorporated by reference. In some embodiments, the outer surface of the oil-in-water Pickering emulsifier particles exhibits a contact angle with water of 50-95°; in some embodiments 60-90°; in some embodiments 70-90°; and in some embodiments 75-90°. Suitable oil-in-water Pickering emulsifier particles may include particles comprising silica, fumed silica, calcium carbonate, barium sulfate, clay, carbon black, iron oxide, carbon nanotubes, latex, block copolymer micelles, polystyrene, poly(methyl methacrylate), and combinations thereof. In addition, any of the preceding materials may be surface-modified to alter hydrophilic/hydrophobic properties. In one preferred embodiment, the oil-in-water Pickering emulsifier particles comprise fumed silica surface-modified with organic silanes or organic siloxanes. Additional suitable Pickering emulsifiers may be listed in Chevalier et al., “Emulsions stabilized with solid nanoparticles: Pickering emulsions”, Colloids and Surfaces A: Physicochem. Eng. Aspects 439 (2013) 23-34; and Binks, “Particles as surfactants—similarities and differences”, Current Opinion in Colloid & Interface Science 7 (2002) 21-41; the contents of which is incorporated by reference. The oil-in-water Pickering emulsifier particles may have an average diameter of 5-1000 nanometers, 5-500 nanometers, 5-200 nanometers, 5-100 nanometers, or in some embodiments 5-50 nanometers.

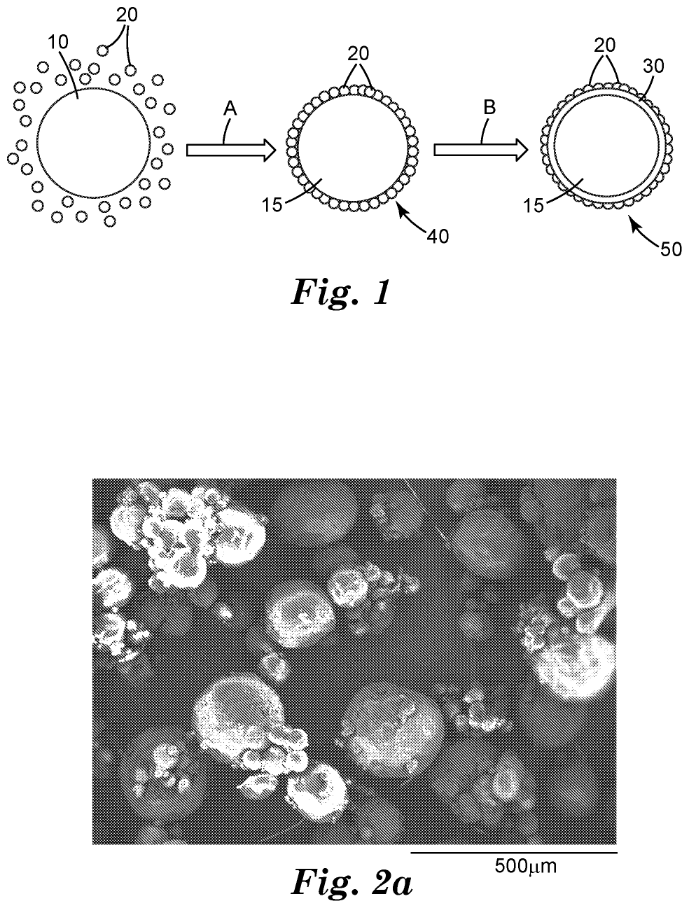

With reference to FIG. 1, particles of encapsulated epoxy resin according to the present disclosure may be manufactured as follows. An aqueous suspension of oil-in-water Pickering emulsifier particles 20 is mixed with an aqueous suspension of epoxy resin 10. The aqueous suspension of epoxy resin 10 additionally includes a diisocyanate. In step A, the combined suspensions are emulsified by application of rapid mixing and moderate heat (e.g., 1000 rpm at 60° C.) to form micelles 40 comprising epoxy resin core 15 and an outer layer of oil-in-water Pickering emulsifier particles 20. In step B, a polyamine is added with continuing mixing. Polymerization reaction of the polyamine with the diisocyanate produces polyurea shell 30 surrounding epoxy resin core 15. Oil-in-water Pickering emulsifier particles 20 form an outer layer of the particle of encapsulated epoxy resin 50. Particles of encapsulated epoxy resin 50 may be collected by filtration and dried. An organic polymeric surfactant or non-particulate organic polymeric surfactant may be substituted for oil-in-water Pickering emulsifier particles 20 to form particles of encapsulated epoxy resin with a surface layer of organic polymeric surfactant or non-particulate organic polymeric surfactant instead of oil-in-water Pickering emulsifier particles.

The particles of encapsulated epoxy resin according to the present disclosure may be used in epoxy adhesive formulations. Since the curable epoxy is sequestered, the particles of encapsulated epoxy resin can be blended with epoxy curative to form one-part epoxy adhesives with long shelf life and high stability, yet which cure to form strong structural bonds. Such adhesive formulations may be solid or liquid at NTP. Cure may be initiated by activation of the particles of encapsulated epoxy resin so as to allow chemical reaction between the encapsulated epoxy resin and the curative. Activation may be accomplished by any suitable method, which may include one or more of heat, mechanical disruption (e.g., by crushing between adherends, sonication, or the like) or other methods leading to shell rupture, shell wall thinning, shell wall softening, shell wall dissolution, shell wall permeabilization, or the like. When heat is used to activate the particles of encapsulated epoxy resin, the activation temperature may be, in various embodiments, not more than 200° C., not more than 170° C., not more than 110° C., or not more than 80° C.

Any suitable epoxy curative may be used with the particles of encapsulated epoxy resin according to the present disclosure. Suitable epoxy curatives may be solid or liquid at NTP. In some embodiments, suitable curatives may be selected from polyamides, polyamines, polymercaptans, anhydrides, imidazoles, and combinations thereof. In some embodiments, the curative may be partially cured or under-cured by reaction with a minor amount of an epoxy resin, which may be the same or different from the epoxy resin that forms the core of the particles of encapsulated epoxy resin. This approach may be used to render the curative a solid at NTP.

### Curable Tapes

The present disclosure provides curable pressure sensitive adhesive tapes comprising: a) a pressure sensitive adhesive polymer; b) particles of encapsulated first epoxy resin (microcapsules) mixed into the pressure sensitive adhesive polymer; and c) an epoxy curative. In some embodiments, the epoxy curative is blended into the pressure sensitive adhesive. In other embodiments, the epoxy curative is the pressure sensitive adhesive polymer. Typically, the epoxy curative is not encapsulated. Typically, the curable pressure sensitive adhesive tape is a freestanding film. Typically, the tape may be cured to form a structural bond between adherends.

Any suitable epoxy curative may be used in the tapes according to the present disclosure. Suitable epoxy curatives may be solid or liquid at NTP. Suitable epoxy curatives are NTP PSA's, are modified to become NTP PSA's, or are incorporated into NTP PSA's. In various embodiments, suitable curatives may be selected from polyamides, polyamines, polymercaptans, anhydrides, imidazoles, and combinations thereof.

In embodiments where the epoxy curative is the pressure sensitive adhesive polymer, a NTP solid curative with PSA character may be used. In some such embodiments, the curative may be partially cured or under-cured by reaction with a minor amount of an epoxy resin, which may be the same or different from the epoxy resin that forms the core of the particles of encapsulated epoxy resin, to render it an NTP PSA material. In some such embodiments the PSA epoxy curative is an adduct of an epoxy curative and an epoxy resin in a ratio of at least 2:1 second epoxy curative to second epoxy resin; in some embodiments at least 3:1; in some embodiments at least 4:1; in some embodiments at least 5:1; in some embodiments at least 6:1; in some embodiments at least 8:1; in some embodiments at least 10:1.

In embodiments where the epoxy curative is blended into a pressure sensitive adhesive polymer, NTP solid or NTP liquid epoxy curatives may be used. In such embodiments, any suitable PSA polymer may be used, which may include rubbers, poly(meth)acrylates, silicones, block copolymers, star block copolymers, or the like, any of which may be tackified or untackified.

In some embodiments, curable pressure sensitive adhesive tapes according to the present disclosure may be manufactured by mixing particles of encapsulated epoxy resin according to the present disclosure into a NTP liquid epoxy curative and adding a minor amount of an epoxy resin, sufficient to render the epoxy curative a NTP solid PSA material upon cure. The mixture may be coated out to an appropriate thickness and cured under conditions sufficient to cure the epoxy resin/epoxy curative mixture but not so rigorous as to activate the particles of encapsulated epoxy resin.

In some embodiments, curable pressure sensitive adhesive tapes according to the present disclosure may be used to affix substrates or adherends by bringing the tape into contact with a first substrate; bringing the remaining exposed face of the tape into contact with a second substrate; and heating the curable pressure sensitive adhesive tape to a curing temperature, which is a temperature sufficient to activate the particles of encapsulated first epoxy resin and cure the first epoxy resin. The curing temperature (activation temperature) may be, in various embodiments, not more than 200° C., not more than 170° C., not more than 110° C., or not more than 80° C.

In some embodiments, constructions obtained by the use of curable pressure sensitive adhesive tapes according to the present disclosure comprise a first substrate bound to a second substrate by a layer of cured epoxy resin. In some such cases, the layer of cured epoxy resin is directly bound to the first substrate, the second substrate, or both. Such constructions may be uniquely characterized by the presence of shells which are artifacts of the particles of encapsulated epoxy resin. The shells may have an average diameter of 0.1-1000 micrometers, 1-1000 micrometers, 5-500 micrometers, or 30-300 micrometers. The shells may comprise an organic polymer, such as polyurea, polyurethane, polymethylene urea, cured epoxy resin, or combinations thereof. The shells may additionally comprise a layer of emulsifier borne on a surface of the shells. in some embodiments, the shells may additionally comprise a layer of oil-in-water Pickering emulsifier particles borne on a surface of the shells, as described herein.

Additional embodiments are recited in the Selected Embodiments and Examples below.

### SELECTED EMBODIMENTS

The following embodiments, designated by letter and number, are intended to further illustrate the present disclosure but should not be construed to unduly limit this disclosure.

T1. A curable pressure sensitive adhesive tape comprising:
a) a pressure sensitive adhesive polymer;
b) particles of encapsulated first epoxy resin mixed into the pressure sensitive adhesive polymer; and
c) a first epoxy curative;
   wherein i) the first epoxy curative is blended into the pressure sensitive adhesive or ii) the first epoxy curative is the pressure sensitive adhesive polymer.
   T2. The curable pressure sensitive adhesive tape according to embodiment T1 wherein the first epoxy curative is not encapsulated.
   T3. The curable pressure sensitive adhesive tape according to embodiment T1 or T2 wherein the first epoxy curative is blended into the pressure sensitive adhesive.
   T4. The curable pressure sensitive adhesive tape according to embodiment T1 or T2 wherein the first epoxy curative is the pressure sensitive adhesive.
   T5. The curable pressure sensitive adhesive tape according to embodiment T4 wherein the first epoxy curative is an adduct of a second epoxy curative and a second epoxy resin in a ratio of at least 2:1 second epoxy curative to second epoxy resin.
   T6. The curable pressure sensitive adhesive tape according to embodiment T5 wherein the second epoxy curative is selected from the group consisting of polyamides, polyamines, polymercaptans, anhydrides, imidazoles, and combinations thereof.
   T7. The curable pressure sensitive adhesive tape according to embodiment T5 wherein the second epoxy curative is a polyamide or a polyamine.
   T8. The curable pressure sensitive adhesive tape according to any of embodiments T1-T7 wherein the first epoxy curative is selected from the group consisting of polyamides, polyamines, polymercaptans, anhydrides, imidazoles, and combinations thereof.
   T9. The curable pressure sensitive adhesive tape according to any of embodiments T1-T7 wherein the first epoxy curative is a polyamide or a polyamine.
   T10. The curable pressure sensitive adhesive tape according to any of embodiments T1-T9 wherein the particles of encapsulated first epoxy resin comprise a core of first epoxy resin within a shell comprising an organic polymer.
   T11. The curable pressure sensitive adhesive tape according to embodiment T10 wherein the shell comprises a polymer selected from the group consisting of polyurea, polyurethane, polymethylene urea, cured epoxy resin, and combinations thereof.
   T12. The curable pressure sensitive adhesive tape according to any of embodiments T10-T11 wherein the particles of encapsulated first epoxy resin additionally comprise a layer of inorganic particles borne on an outer surface of the shell.
   T13. The curable pressure sensitive adhesive tape according to embodiment T12 wherein the inorganic particles comprise fumed silica.
   T14. The curable pressure sensitive adhesive tape according to any of embodiments T1-T13 wherein the particles of encapsulated first epoxy resin have an average diameter of 0.1-1000 micrometers.
   T15. A method of affixing substrates comprising:
a) bringing a curable pressure sensitive adhesive tape according to any of embodiments T1-T14 into contact with a first substrate;
b) bringing the curable pressure sensitive adhesive tape into contact with a second substrate; and
c) heating the curable pressure sensitive adhesive tape to a curing temperature, which is a temperature sufficient to activate the particles of encapsulated first epoxy resin and cure the first epoxy resin.
   T16. The method according to embodiment T15, wherein the curing temperature is not more than 170° C.
   T17. The method according to embodiment T15, wherein the curing temperature is not more than 80° C.
   T18. A construction comprising a first substrate bound to a second substrate by a layer of cured epoxy resin, wherein the layer of cured epoxy resin comprises shells comprising an organic polymer.
   T19. The construction according to embodiment T18 wherein the shells comprise a polymer selected from the group consisting of polyurea, polyurethane, polymethylene urea, cured epoxy resin, and combinations thereof.
   T20. The construction according to any of embodiments T18-T19 wherein the shells comprise a layer of oil-in-water Pickering emulsifier particles borne on a surface of the shells.
   T21. The construction according to embodiment T20 wherein the oil-in-water Pickering emulsifier particles comprise fumed silica.
   T22. The construction according to any of embodiments T18-T21 wherein the shells have an average diameter of 0.1-1000 micrometers.
   T23. The curable pressure sensitive adhesive tape according to any of embodiments T1-T14 wherein the particles of encapsulated first epoxy resin are the particles of encapsulated first epoxy resin according to any of embodiments P1-P13.
   P1. Particles of encapsulated first epoxy resin comprising
a) a core of first epoxy resin, within
b) a shell comprising an organic polymer, and
c) a layer of oil-in-water Pickering emulsifier particles borne on an outer surface of the shell.
   P2. The particles according to embodiment P1 comprising not more than 50 wt %, based on the weight of oil-in-water Pickering emulsifier particles, of an organic polymeric surfactant.
   P3. The particles according to embodiment P1 comprising not more than 10 wt %, based on the weight of oil-in-water Pickering emulsifier particles, of an organic polymeric surfactant.
   P4. The particles according to any of embodiments P1-P3 having an average diameter of 0.1-1000 micrometers.
   P5. The particles according to any of embodiments P1-P4 wherein the shell comprises an organic polymer selected from the group consisting of polyurea, polyurethane, polymethylene urea, cured epoxy resin, and combinations thereof.
   P6. The particles according to any of embodiments P1-P4 wherein the shell comprises a polyurea polymer.
   P7. The particles according to any of embodiments P1-P6 wherein the oil-in-water Pickering emulsifier particles comprise materials selected from the group consisting of silica, fumed silica, calcium carbonate, barium sulfate, clay, carbon black, iron oxide, carbon nanotubes, latex, block copolymer micelles, polystyrene, poly(methyl methacrylate), any of the preceding materials which additionally are surface-modified, and combinations thereof.
   P8. The particles according to any of embodiments P1-P6 wherein the oil-in-water Pickering emulsifier particles comprise fumed silica surface-modified with organic silanes or organic siloxanes.
   P9. The particles according to any of embodiments P1-P7 wherein the oil-in-water Pickering emulsifier particles have an outer surface, wherein the outer surface exhibits a contact angle with water of 50-95°.
   P10. The particles according to any of embodiments P1-P7 wherein the oil-in-water Pickering emulsifier particles have an outer surface, wherein the outer surface exhibits a contact angle with water of 60-90°.
   P11. The particles according to any of embodiments P1-P10 wherein the oil-in-water Pickering emulsifier particles have an average diameter of 5-1000 nanometers.
   P12. The particles according to any of embodiments P1-P11 which activate upon heating to a activation temperature, wherein the activation temperature is not more than 170° C.
   P13. The particles according to embodiment P12, wherein the activation temperature is not more than 80° C.
   P14. A composition comprising:
A) the particles according to any of embodiments P1-P13, blended with
B) a first epoxy curative.
   P15. The composition according to embodiment P14 wherein the first epoxy curative is an adduct of a second epoxy curative and a second epoxy resin in a ratio of at least 2:1 second epoxy curative to second epoxy resin.
   P16. The composition according to embodiment P15 wherein the second epoxy curative is selected from the group consisting of polyamides, polyamines, polymercaptans, anhydrides, imidazoles, and combinations thereof.
   P17. The composition according to embodiment P15 wherein the second epoxy curative is a polyamide or polyamine.
   P18. The composition according to any of embodiments P14-P17 wherein the first epoxy curative is selected from the group consisting of polyamides, polyamines, polymercaptans, anhydrides, imidazoles, and combinations thereof.
   P19. The composition according to any of embodiments P14-P17 wherein the first epoxy curative is a polyamide or polyamine.
   P20. An adhesive comprising
I) particles of encapsulated first epoxy resin comprising
   a) a core of first epoxy resin, within
   b) a shell comprising an organic polymer, and
   c) a layer of oil-in-water Pickering emulsifier particles borne on an outer surface of the shell;
blended with
II) a first epoxy curative;
   wherein the adhesive is a liquid at normal temperature and pressure (NTP).
   P21. The adhesive according to embodiment P20 which is a one-part structural adhesive.
   MP1. A method of making particles of encapsulated first epoxy resin according to any of embodiments P1-P13 comprising:
A) blending in aqueous suspension
   i) a curable epoxy resin,
   ii) oil-in-water Pickering emulsifier particles, and
   iii) a first co-monomer to form a blend;
B) emulsifying the blend to form micelles comprising a core of curable epoxy resin and an outer layer of oil-in-water Pickering emulsifier particles;
C) adding a second co-monomer reactive with the first co-monomer to form a copolymer; and
D) copolymerizing the first and second co-monomers to form a copolymer shell enclosing the core of curable epoxy resin.
   MP2. The method according to embodiment MP1 wherein the first co-monomer is a diisocyanate or polyisocyanate.
   MP3. The method according to embodiment MP1 or MP2 wherein the second co-monomer is a diamine, polyamine, diol, or polyol.
   MP4. The method according to embodiment MP1 or MP2 wherein the second co-monomer is a diamine or polyamine.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods.

### Materials

| Designation | Description |
|---|---|
| EPON 815C | EPON ™ 815C, a liquid bisphenol A based, low viscosity |
| | epoxy resin obtained from Hexion, Columbus, OH |
| EPIKURE 3115 | EPIKURE ™ 3115, a polyamide epoxy curing agent |
| | obtained from Hexion, Columbus, OH |
| LUPRANATE | LUPRANATE ® 224, a medium viscosity polymeric |
| 224 | MDI containing a high amount of 2,4′-diphenylmethane |
| | diisocyanate, manufactured by BASF Corp., Florham |
| | Park, New Jersey. |
| ANQUAMINE | ANQUAMINE ® 401, a modified aliphatic amine (70% |
| 401 | solid in water), manufactured by Evonik Industries, AG, |
| | Essen, Germany. |
| AEROSIL R816 | AEROSIL ® R816, a fumed silica surface modified with |
| | hexadecylsilane, manufactured by Evonik Industries, |
| | AG, Essen, Germany. |
| PVA | Polyvinyl alcohol (80% hydrolyzed) obtained from |
| | Aldrich Chemical Co., Milwaukee, WI. |
| DETA | Diethylenetriamine obtained from Aldrich Chemical Co., |
| | Milwaukee, WI. |

### Test Methods

### Overlap Shear Strength Test

For overlap sheer strength measurement, the adhesive film was used to bond two 1″ (2.54 cm) wide aluminum coupons with 0.5″ (1.27 cm) overlap. Coupons were cleaned with acetone and allowed to dry before application of adhesive. The adhesive was cured at the indicated temperature for 1 hour. Some samples were clamped during cure, whereas other samples (“unclamped”) were not clamped and were hung vertically during cure. A dynamic overlap shear test was performed at ambient temperature using an Instron Tensile Tester (Instron, model 5581 equipped with a 10,000 N load cell). Test specimens were loaded into the grips and the crosshead was operated at 10 mm per minute, loading the specimen to failure. Stress at break was recorded.

### 90° Peel Test

For the peel test, adhesive film samples were laminated with a VHB tape having a polyethylene backing, resulting in a tape with an overall adhesive thickness of −1.0 mm. The tape was adhered on the indicated substrates, with the adhesive film to be tested facing the substrate, using a #4.5 roller for 4 passes. Substrates were cleaned with acetone and allowed to dry before application of adhesive. Tapes were then peeled from substrates and 90° peel adhesion was measured using an Instron Tensile Tester (Instron, model 5581 equipped with a 500 N load cell) operated at 12″ (30.5 cm) per minute.

### EXAMPLES

### Preparation and Characterization of Particles of Encapsulated Epoxy Resin (Ex. 1, C. Ex. A)

The encapsulation was carried out in a jacketed 1 L glass reactor fitted with a baffle. The reactor temperature was controlled through a water bath. A Ruston turban was used as the mixer and was placed 0.5″ above the bottom of the reactor. In the reactor, 4 g Aerosil R816 (for Example 1) or 4 g PVA (for Comparative Example A) was added into 400 mL water with a mixing rate at 1000 rpm at 60° C. Separately, 30 g Lupranate 224 was mixed with 170 g Epon 815C in a beaker and the mixture was then added into the aqueous solution. The emulsification was allowed for 10 min before 14.7 g diethylenetriamine (DETA) was added to the mixture. After certain reaction time, the suspension was filtered and the particles of encapsulated epoxy resin were washed with water on the filter and dried in oven at 70° C. for 2 hours.

After drying, particles of encapsulated epoxy resin according to Comparative Example A were found to clump to form aggregates that were a little rubbery and difficult to break down. In contrast, particles of encapsulated epoxy resin according to Example 1 could be easily separated into discrete particles and the resulting powder had good flowability.

The size and size distribution of particles of encapsulated epoxy resin according to Example 1 and Comparative Example A were measured using Malvern Mastersizer (Malvern Panalytical Ltd., UK). Comparative Example A demonstrated an average particle size of 81 um with a broad distribution, while the average particle size of Example 1 was 114 um with a distribution several times narrower.

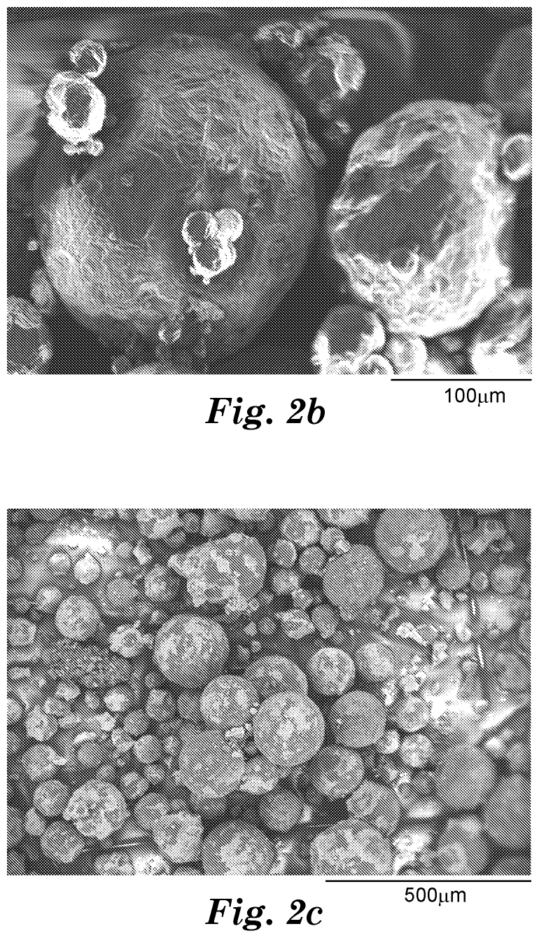

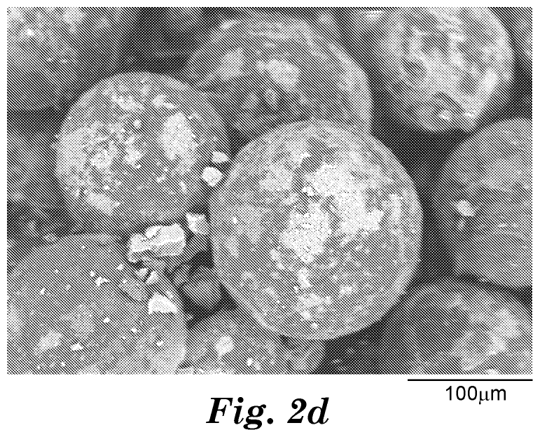

The morphology of particles of encapsulated epoxy resin according to Comparative Example A and Example 1 was studied using SEM using a Hitachi FlexSEM 1000. FIG. 2(a)-(d) are SEM micrographs of particles of encapsulated epoxy resin according to Comparative Example A (FIGS. 2(a) and (b)) and Example 1 (FIGS. 2(c) and (d)). Compared to particles of encapsulated epoxy resin according to Comparative Example A, the particles of Example 1 are more round and smooth. This suggests that the Pickering emulsifier used in Example 1 resulted in a more mechanically stable emulsion.

Elemental analysis of the surface of particles of encapsulated epoxy resin according to Comparative Example A and Example 1 was studied using EDX. The major elements on the surface of particles of Comparative Example A were carbon and oxygen, assignable to PVA. The major elements on the surface of particles of Example 1 were carbon, oxygen, and silicon, demonstrating a surface layer of the surface-modified silica particles (Aerosil R816). Elemental mapping of carbon, oxygen, and silicon on the surface of particles of Example 1 demonstrated 100% coverage of the surface with surface-modified silica particles.

### Preparation and Characterization of Liquid Adhesive Formulations (Exs 2 &3)

Two liquid adhesive formulations (Examples 2 & 3) were made by manually mixing the particles of encapsulated epoxy resin of Example 1 (i.e., those made using Aerosil R816 as a Pickering emulsifier) with Anquamine 401 and Epikure 3115, respectively. Anquamine 401 was dried at 60° C. for 2 hours before mixing with particles of encapsulated epoxy resin from Example 1 at a weight ratio of 2:3. Epikure 3115 was mixed with particles of encapsulated epoxy resin from Example 1 at a weight ratio of 1:1.

Samples of each of the two formulations were aged at two sets of conditions: at room temperature for 3 days, and at 70° C. for 7 days. In all four cases, samples remained stable under the aging conditions. After aging, samples were taken and curing behavior was analyzed using DSC using TA Instruments Q100 with heating rate of 20° C./min to 310°. The room temperature aged Example 2 and Example 3 showed onset temperatures at 151° C. and 191° C., indicating the dependence of the onset temperature on the type of curative. The 70° C./7 days aged Example 2 formulation showed a lower onset temperature (135° C. vs. 151° C.) with a slightly reduced exotherm (266 J/g vs. 294 J/g) in comparison to the room temperature aged sample. Similar behavior was observed for the Example 3 formulation with lowered onset temperature and reduced exotherm.

### Preparation and Characterization of Structural Bonding Tapes (Ex. 4)

Epikure 3115 was manually mixed with dry particles of encapsulated epoxy resin of Example 1 (i.e., those made using Aerosil R816 as a Pickering emulsifier) in a 10:9 weight ratio and the mixture was heated in oven at 40° C. for 30 min. 1 part by weight (relative to Epickure 3115) of Epon 815C was then added to the mixture and manually mixed to an even distribution. The mixture was coated on a silicone release paper using a handheld knife coater to form a 0.5 mm thick adhesive film. The film was cured at 60° C. for 1 hour, resulting in structural bonding tapes (transfer tapes) of Example 4.

90° peel testing was performed on the uncured structural bonding tape of Example 4 in accordance with the procedure described above, using stainless steel, glass, PVC, and LDPE substrates. The results, summarized in Table 1, demonstrate that the structural bonding tape of Example 4 has pressure sensitive adhesive character prior to cure.

TABLE 1

| Substrate | Peel adhesion (N/m) | Peel adhesion (lbf/in) |
|---|---|---|
| stainless steel | 858.1 | 4.9 |
| Glass | 753.0 | 4.3 |
| PVC | 910.6 | 5.2 |
| LDPE | 665.4 | 3.8 |

Overlap shear strength testing was performed on the structural bonding tape of Example 4 in accordance with the procedure described above. Results are summarized in Table 2.

TABLE 2

| | | Overlap Shear | | |
|---|---|---|---|---|
| | Clamped/ | Strength | Elongation at | |
| Cure Temp. | Unclamped | MPa(psi) | Break | Failure Mode |
| 130° C. | Clamped | 0.73 (105.5) | | Cohesive |
| 160° C. | Clamped | 16.2 (2342.8) | 14.6% | Cohesive |
| 190° C. | Clamped | 12.6 (1824.4) | 6.9% | Adhesive |
| 190° C. | Unclamped | 6.2 (902.8) | | Adhesive |

The unclamped sample was hung vertically from a rack in the curing oven during the cure, yet did not separate or show delamination during or after cure due to the pressure sensitive adhesive character of the adhesive prior to cure. However, the corresponding clamped sample demonstrated greater shear strength than the unclamped sample. Visual examination of cured samples revealed that the clamped samples showed minor adhesive oozing from the sides due to the clamping force and adhesive flow at elevated temperature. It is estimated that there was 0.2 mm thickness of adhesive between the two coupons after curing which was responsible for the observed shear strength.

Curing temperature was evaluated in order to understand its influence on shear strength. 130° C. cure resulted in a low shear strength. High shear strength was obtained with cure at 160° C. and 190° C. Without wishing to be bound by theory, Applicants believe the higher shear strength obtained at 160° C. versus 190° C. was due to greater flexibility in the 160° C. cured material, reflected by the higher value of elongation at break.

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A curable pressure sensitive adhesive tape comprising:
a) a pressure sensitive adhesive polymer;
b) particles of encapsulated first epoxy resin mixed into the pressure sensitive adhesive polymer; and
c) a first epoxy curative;
wherein i) the first epoxy curative is blended into the pressure sensitive adhesive or ii) the first epoxy curative is the pressure sensitive adhesive polymer.

2. The curable pressure sensitive adhesive tape according to claim 1, wherein the first epoxy curative is not encapsulated.

3. The curable pressure sensitive adhesive tape according to claim 1, wherein the first epoxy curative is blended into the pressure sensitive adhesive.

4. The curable pressure sensitive adhesive tape according to claim 1, wherein the first epoxy curative is the pressure sensitive adhesive.

5. The curable pressure sensitive adhesive tape according to claim 4, wherein the first epoxy curative is an adduct of a second epoxy curative and a second epoxy resin in a ratio of at least 2:1 second epoxy curative to second epoxy resin.

6. The curable pressure sensitive adhesive tape according to claim 5, wherein the second epoxy curative is selected from the group consisting of polyamides, polyamines, polymercaptans, anhydrides, imidazoles, and combinations thereof.

7. The curable pressure sensitive adhesive tape according to claim 5, wherein the second epoxy curative is a polyamide or a polyamine.

8. The curable pressure sensitive adhesive tape according to claim 1, wherein the particles of encapsulated first epoxy resin comprise a core of first epoxy resin within a shell comprising an organic polymer.

9. The curable pressure sensitive adhesive tape according to claim 8, wherein the shell comprises a polymer selected from the group consisting of polyurea, polyurethane, polymethylene urea, cured epoxy resin, and combinations thereof.

10. The curable pressure sensitive adhesive tape according to claim 8, wherein the particles of encapsulated first epoxy resin additionally comprise a layer of oil-in-water Pickering emulsifier particles borne on a surface of the shells.

11. A method of affixing substrates comprising:
a) bringing a curable pressure sensitive adhesive tape according to claim 1, into contact with a first substrate;
b) bringing the curable pressure sensitive adhesive tape into contact with a second substrate; and
c) heating the curable pressure sensitive adhesive tape to a curing temperature, which is a temperature sufficient to activate the particles of encapsulated first epoxy resin and cure the first epoxy resin.

12. The method according to claim 11, wherein the curing temperature is not more than 170° C.

13. A construction comprising a first substrate bound to a second substrate by a layer of cured epoxy resin, wherein the layer of cured epoxy resin comprises shells comprising an organic polymer.

14. The construction according to claim 13, wherein the shells comprise a polymer selected from the group consisting of polyurea, polyurethane, polymethylene urea, cured epoxy resin, and combinations thereof.

15. The construction according to claim 13, wherein the shells comprise a layer of oil-in-water Pickering emulsifier particles borne on a surface of the shells.

16. The construction according to claim 15, wherein the oil-in-water Pickering emulsifier particles comprise fumed silica.

17. The method according to claim 11, wherein the curing temperature is not more than 80° C.

18. The curable pressure sensitive adhesive tape according to claim 10, wherein the oil-in-water Pickering emulsifier particles comprise fumed silica.

19. The curable pressure sensitive adhesive tape according to claim 1, wherein the first epoxy curative is selected from the group consisting of polyamides, polyamines, polymercaptans, anhydrides, imidazoles, and combinations thereof.

20. The curable pressure sensitive adhesive tape according to claim 1, wherein the first epoxy curative is a polyamide or a polyamine.
